(19) United States
(12) Patent Application Publication
(10) Pub. No.: US 2020/0379491 A1
(43) Pub. Date: Dec. 3, 2020

(54) Flowrate Control System and Method

(71) Applicant: Hugh Hazen Wilson, IV, Los Angeles, CA (US)

(72) Inventor: Hugh Hazen Wilson, IV, Los Angeles, CA (US)

(21) Appl. No.: 16/279,718

(22) Filed: Feb. 19, 2019

(51) Int. Cl. G05D 16/20; E03B 7/07

(52) U.S. Cl. CPC G05D 16/2013; E03B 7/075

(57) ABSTRACT

A system and method to for monitoring and controlling the flow of a liquid or gas through a passageway is presented. The system may include a flow meter assembly, a pressure sensing assembly, a valve assembly, a controller, a cloud platform and a mobile app.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to devices that monitor and control the flow of a liquid or gas through a passageway.

### BACKGROUND

Water conservation is an important topic and of high interest in most communities. However, most residences do not understand or even realize how much water they may use in a day, a week, a month or a year.

Currently, a user of water in a building (whether it may be a residential building or a commercial building) may receive a water bill that may outline the water used during the billing period. However, the statements are often difficult to understand and as such, the user may not fully appreciate the amount of his/her usage.

And while there may be water usage monitoring systems available that may measure the amount of water flowing into a building, the systems are very limited in the functionalities that they may provide to the users of the systems. For example, the current systems may not allow a user to monitor and control the water flow through their pipelines remotely.

Accordingly, there is a need for a system and method of remotely monitoring and controlling the flowrate of water through a pipeline.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1-2 depict aspects of a flowrate control system according to exemplary embodiments hereof; and

FIG. 3 depicts aspects of a computing system according to exemplary embodiments hereof.

### DETAILED DESCRIPTION OF THE PREFERRED EMBODIMENTS

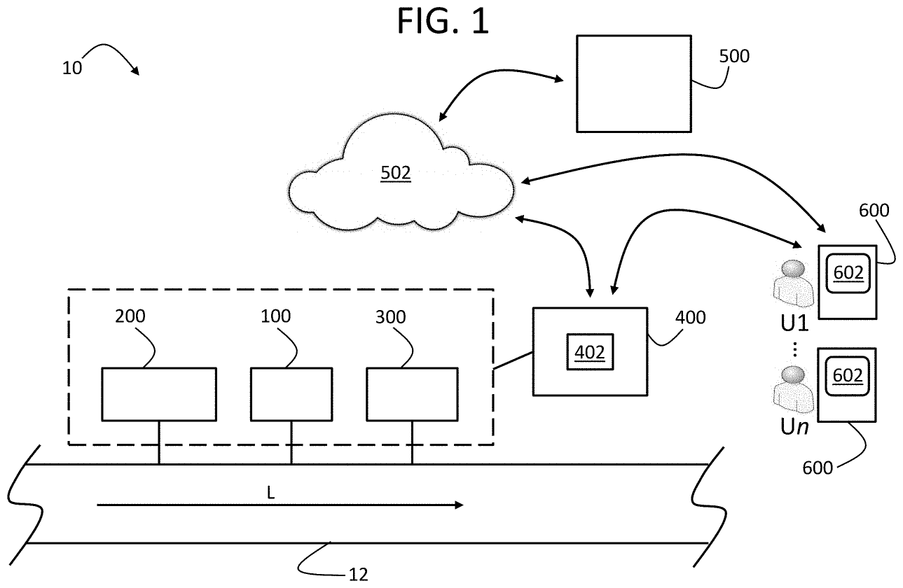

A system or framework according to exemplary embodiments hereof is described here with reference to the drawings of FIGS. 1-3.

In general, the system 10 may include a device, mechanism or system that may monitor, measure, regulate and/or control the volumetric flowrate and/or the mass flowrate of a fluid, liquid or gas flowing through a passageway such as a pipe, tube, hose, conduit, pipeline, duct, channel or other type of passageway. For example, the system 10 may measure, regulate and/or control the flow of water as it passes through a water pipeline of a residential or commercial building. The system 10 may be controlled locally or remotely, and may be manual or automatic or any combination thereof. In this way, the water flow through the pipeline may be monitored, regulated and/or controlled by the system 10 as desired, allowing for water conservation initiatives to be implemented.

As shown in FIG. 1, in one exemplary embodiment hereof the system 10 may include a flow meter assembly 100, a pressure sensing assembly 200, a valve assembly 300, a controller assembly 400, and a cloud platform 500. The system 10 may also include control software such as an application 402 (e.g., a mobile app, a desktop app and/or other types of apps, widgets or software).

For demonstration purposes, FIG. 1 shows the system 10 and its assemblies 100, 200, 300 configured with a pipe 12 to monitor and/or control various characteristics of the liquid L that may be flowing through it. While the direction of the flow of the liquid L is shown as left to right (indicated by an arrow), the flow of the liquid L may also be right to left or any combination thereof. The configurations between the assemblies 100, 200, 300 of the system 10 and the pipe 12 are represented by solid line and may be intrusive and/or non-intrusive and/or any combination thereof. The assemblies 100, 200 and 300 may be configured in series, in parallel or in any combination thereof. The assemblies 100, 200, 300 may also be configured in any order with respect to one another and the pipe 12 as necessary to fulfill their functionalities. Additional details regarding the assemblies 100, 200, 300 and the configuration of the system 10 with a pipe 12 or other type of passageway will be described next in further detail.

### Flow Meter Assembly

In one exemplary embodiment hereof, the system 10 may include a flow meter assembly 100 that may include a device or system that may measure the volumetric flowrate and/or the mass flowrate of a fluid, liquid or gas flowing through a passageway of interest. For example, the flow meter assembly 100 may be configured with the pipe 12 (FIG. 1) to measure the flowrate of the liquid L therein.

The flow meter assembly 100 may include without limitation any type or any combination of types of flow meters such as differential pressure flow meters, positive displacement flow meters, velocity flow meters, mass flow meters, electromagnetic flow meters, open channel flow meters and other types of flow meters. The flow meter assembly 100 may also include ultrasonic flow meters, turbine flow meters, paddlewheel sensors, vortex meters, rotameters, spring and piston flow meters, or other types of flow meters.

The flow meter assembly 100 may preferably include a data output device that may provide an indication of the measured volumetric flowrate and/or the measured mass flowrate of the fluid, liquid or gas flowing through the passageway of interest. In one preferred embodiment hereof, the flow meter assembly 100 may output an electrical signal (e.g., an analog signal, a digital signal or a signal of any combination thereof) that may represent the volumetric flowrate and/or the mass flowrate of the liquid at any point in time at the point of measurement (preferably in real time). The electrical signals may be communicated to the controller assembly 400 for encoding, analysis, display and/or for other purposes.

In one exemplary embodiment hereof, the flow meter assembly 100 may be implemented to take continual readings of the volumetric flowrate and/or the mass flowrate of the liquid L, and to communicate the continual stream of measurement data to the controller assembly 400. In another exemplary embodiment hereof, the flow meter assembly 100 may be controlled (e.g., by the controller assembly 400) to take readings periodically (e.g., at pre-specified intervals) and to communicate the readings to the controller assembly 400 at the same or different intervals. In another exemplary embodiment hereof, the controller assembly 400 may trigger the flow meter assembly 100 to take readings at any point in time (e.g., when desired and implemented by the user) and to communicate the measurement data to the controller 400. It is understood that any combination of the above embodiments may also be implemented.

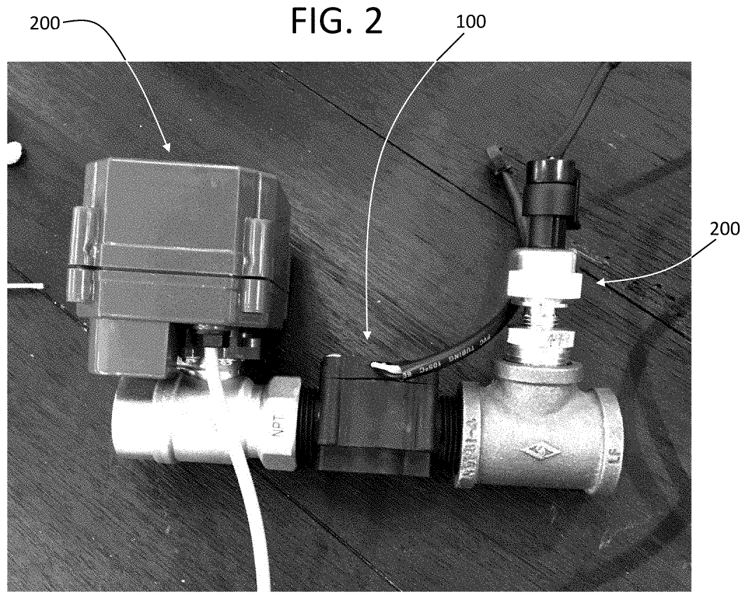

In one preferred implementation as shown in FIG. 2, the flow meter 100 may include a model FS300A flow meter manufactured by UMEAN. In this implementation, the flow meter may be configured in line with the pipe 12 and may include an internal impeller that may rotate in proportion to the flow rate of the liquid L being measured through the pipe 12. The impeller may include magnetic elements that may be sensed by Hall effect sensors that may be configured with the flow meter 100. In this way, the rotational speed of the impeller may be sensed by the Hall effect sensors, converted to a signal that is proportional to the measured water flow and transmitted to the controller 400. Alternatively, the flow meter 100 may communicate the raw data to the controller 400 and the controller 400 may perform the encoding of the data. In one example, the output of the Hall effect sensors may be a square-wave pulse that may be proportional to the speed of the impeller, and thus to the volumetric flowrate and/or mass flowrate of the fluid, liquid or gas flowing through the passageway 12. It is understood that this example is meant for demonstrational purposes and that any type or make of any adequate flow meter 100 may be utilized with the system 10.

### Pressure Sensing Assembly

In one exemplary embodiment hereof, the system 10 may include a pressure sensing assembly 200 that may include a device that may measure the pressure of a gas or liquid of interest. For example, the pressure sensing assembly 200 may be configured with a pipe 12 to measure the pressure of the liquid L flowing through the pipe 12 (as shown in FIG. 1).

The pressure sensing assembly 200 may include without limitation any type of adequate pressure sensing device(s) such as pressure sensors, pressure transducers, pressure transmitters and other types of pressure sensing devices. The pressure sensing assembly 200 may include gauge pressure sensors, absolute pressure sensors, differential pressure sensors, and other types of pressure sensors.

The pressure sensors, transducers and/or transmitters may include strain gauges that may include diaphragms that may deflect depending on the pressure the diaphragm may experience. The pressure sensors, transducers and/or transmitters may also include capacitive pressure sensors that may include MEMS diaphragms and/or piezoelectric pressure sensors that may include materials (e.g., quartz or tourmaline) that may generate electrical energy when under strain.

The pressure sensing assembly 200 may preferably include a data output device that may provide an indication of the measured pressure of the fluid, liquid or gas flowing through the passageway of interest. In one preferred embodiment hereof, the pressure sensing assembly 200 may output an electrical signal (e.g., an analog signal, a digital signal or a signal of any combination thereof) that may represent the pressure of the liquid at any point in time at the point of measurement (preferably in real time). The electrical signals may be communicated to the controller assembly 400 for encoding, analysis, display and/or for other purposes.

In one exemplary embodiment hereof, the pressure sensing assembly 200 may be implemented to take continual readings of the pressure of the liquid L, and to communicate the continual stream of measurement data to the controller assembly 400. In another exemplary embodiment hereof, the pressure sensing assembly 200 may be controlled (e.g., by the controller assembly 400) to take readings periodically (e.g., at pre-specified intervals) and to communicate the readings to the controller assembly 400 at the same or different intervals. In another exemplary embodiment hereof, the controller assembly 400 may trigger the pressure sensing assembly 200 to take readings at any point in time (e.g., when desired and implemented by the user) and to communicate the measurement data to the controller 400. It is understood that any combination of the above embodiments may also be implemented.

In one preferred implementation as shown in FIG. 2, the pressure sensing assembly 200 may include a model TRTV1766 pressure sensing transducer manufactured by Yosoo. It is understood that this example that this example is meant for demonstrational purposes and that any type or make of any adequate pressure sensing device 200 may be utilized with the system 10.

### Valve Assembly

In one exemplary embodiment hereof, the system 10 may include a valve assembly 300 that may include a device such as a flow control valve that may regulate the amount of liquid L that may flow past the valve assembly 300 downstream (e.g., through pipe 12 in FIG. 1). In this way, the water flow rate through the pipe 12 may be controlled.

The valve assembly 300 may include rotary motion valves that may include ball, butterfly, plug or other types of closure devices, and/or linear motion valves that may include globe, diaphragm, pinch or other types of closure devices. The closure device(s) may be controlled to be fully-open (allowing maximum flowrate of the liquid through the valve assembly 300 and thus through the pipe 12), fully-closed (disallowing any flow of the liquid through the valve assembly 300 and thus through the pipe 12), or to a position between fully-open and fully-closed to control the flow rate of the liquid L through the valve assembly 300 and the pipe 12. The closure devices may be controlled by devices such as motors and/or actuators that may accept positional control signals from a controller (e.g., electrical signals from the controller 400) and in response, may adjust the position of the closure device within the valve assembly 300 according to the positional control signal to adjust the amount of flow of the liquid L through the passage way (e.g., the pipe 12) as desired.

In one exemplary embodiment hereof, the system 10 may set the position of the closure device(s) of the valve assembly 300 while taking continual flow rate measurement readings using the flow meter assembly 100. In this way, the flow rate may be sensed as the closure devices may be adjusted, and the closure devices adjustment may continue until a desired flow rate reading may be achieved.

In another exemplary embodiment hereof, the valve assembly 300 may include tracking mechanisms that may track, measure or otherwise determine the position of the closure device(s) and then relay the positional data to the controller 400. In one exemplary implementation, the tracking mechanisms may include one or more magnetic elements configured with each closure device, and one or more Hall effect sensors configured to sense the magnetic fields associated with the one or more magnetic elements. In this way, as the actuator(s) may set the position of the closure devices, the magnetic fields may change and this change may be sensed by the Hall effect sensors. The sensed change in the magnetic field may then be correlated to the position of the closure device(s). It is understood that this example is meant for demonstration purposes and that other types of tracking mechanisms may also be used by the system 10 to track the position of the closure devices.

In this embodiment, prior to use, continually during use and/or at periodic intervals, it may be preferable to calibrate the tracking mechanisms at each position of the closure device(s) with respect to each positional control signal and each resulting flow rate of the liquid L at each positional setting. This may result in a set of calibration factors/coefficients that may correlate each positional control signal to the resulting flow rate of the liquid L through the valve assembly 300.

The calibration coefficients may then be stored in the controller 400, cloud platform 500 or elsewhere and accessed as needed during the operation of the system 10. In this way, it may not be necessary to continually take flow rate measurements using the flow meter assembly 100 at every setting of the closure devices while attempting to achieve the desired valve assembly 300 setting, as this iterative process may take excess time, may cause overshooting of the desired flow rate, and may be prone to other complications such as hysteresis of the valve assembly 300. Instead, the closure devices may be set to a particular setting and the corresponding calibration factor for that setting may be applied to a baseline flow rate for the pipe 12 to determine the new flow rate.

In one example, the calibration may be accomplished by first establishing a baseline flow rate of the liquid L through the pipe 12 using the flow meter assembly 100 and with the valve assembly 300 set to a fully-open setting (maximum flow rate). A positional setting signal may then be sent to the actuator of the valve assembly 300 to set its closure device to a particular position in order to alter the flow rate of the liquid L through the pipe 12. The position of the closure device may then be measured using the tracking mechanisms, and the resulting flow rate of the liquid L through the pipeline 12 may be measured using the flow meter assembly 100. This may be performed for each positional control signal, resulting in set of coefficients that may correlate each positional control signal to the tracked positional setting of each closure device, and to the resulting flow rate of the liquid L through the pipeline 12. It is understood that a non-infinite number of positional control settings may be calibrated, and that the calibration data may be interpolated to determine calibration factors that may not have been directly measured. Other calibration methodologies may also be performed, and it is understood that the scope of the system 10 is not limited in any way by the type of calibration methods used. It is also understood that there may be an uncertainty associated with each calibration factor due to the measurement uncertainties of the assemblies 100, 200, 300 and other components.

In one exemplary embodiment hereof, the conversion of the raw data provided by the Hall effect sensors into data describing the actual position of the closure device(s) and/or the resulting flow rate of the liquid L through the pipeline 12 may be performed by the controller 400, the cloud platform 500, or by a different encoder or controller. This will be described in further detail in other sections.

### Controller

In one exemplary embodiment hereof the system 10 may include a controller 400 that may be configured to send data to one or more of the assemblies 100, 200, 300 (e.g., control signals), and/or to receive data from one or more of the assemblies 100, 200, 300 (e.g., measurement data). The controller 400 may include one or more microprocessors, microcontrollers, encoders, local or remote computers, smartphones, tablet computers, laptops, personal computers, hubs, servers or any other types of controller or any combination thereof. The controller 400 may include drivers to control the different assemblies 100, 200, 300, and may be networked, paired or otherwise configured with one or more of the assemblies 100, 200, 300 as required. The controller 400 may communicate with one or more of the assemblies 100, 200, 300 via wireless technologies, Wi-Fi, Bluetooth, RF, microwave, optical, cellular or other types of wireless technologies. Alternatively the controller 400 and the assemblies 100, 200, 300 may communicate via transmission lines, wires, cables, or via any combination thereof.

As described above, the controller 400 may receive raw measurement data from one or more of the assemblies 100, 200, 300 and may convert the raw data to calibrated measurement data. In this way, the calibrated measurement data may accurately represent the metrics being measured by the assemblies 100, 200, 300 (within an associated uncertainty level).

It may be preferable that the controller 400 be configured and positioned in the local proximity of the assemblies 100, 200 300 and configured therewith; however, this may not be required.

The controller 400 may also communicate with the cloud platform 500 and may relay data from one or more assemblies 100 200 300 or other information to the cloud platform 500 as desired and/or as necessary. In this way, the data may be accessible to users Un (as shown in FIG. 1) who may wish to access the data (e.g., using a mobile app as will be described in other sections).

In one embodiment, the controller 400 may collect and generally aggregate data from one or more of the assemblies 100, 200 300 and then periodically upload some or all of the data to the cloud platform 500. In this way, the system 10 may reduce the amount of bandwidth that it may require and/or utilize. In another embodiment, the controller 400 may collect data from one or more of the assemblies 100, 200, 300 and communicate some or all of the data to the cloud platform 500 on a continual basis. In yet another embodiment, the controller 400 may collect data from one or more of the assemblies 100, 200, 300 and upload some or all of the data to the cloud platform 500 at any desired point in time (e.g., as triggered by the user Un). It is understood that any of these describe methodologies may be utilized in parallel with any other methodology, whether described or otherwise.

The controller 400 may include one or more data indication devices such as displays, meters, LEDs and other types of data readout devices. For example, the controller 400 may include a display that may indicate the values of the various parameters that the assemblies 100, 200, 300 may be measuring at any point in time (preferably calibrated). The controller 400 may also display data bounds and may indicate when a particular parameter may be outside the bounds. It is understood by a person of ordinary skill in the art, upon reading this specification, that the controller 400 may include any type of data display device(s), and that the controller 400 may display or otherwise indicate any type of data, either received directly from the assemblies 100, 200, 300, the cloud platform 500 or elsewhere, derived from data received from the assemblies 100, 200, 300, the cloud platform 500 or elsewhere, or any combination thereof.

The controller 400 may also include visual or audio notifications that may alert the user to various operating conditions. For example, the controller 400 may include a first LED indicator light that may indicate that the controller 400 and its associated assemblies 100, 200, 300 may be operating correctly. The controller 400 may also include a second LED indicator light that may indicate that there may be a problem with the local controller 108 and/or with one or more assemblies 100, 200, 300 or with any other component of system 10. An audio signal (e.g., a continual beeping) may also be employed to bring the problem to the attention of the user Un. Yet another indicator light may indicate that the assemblies 100, 200, 300 may be on the network and communicating with the cloud platform 500, or that there may be a problem with the network or Internet connection. Other types of indicators may also be used for other types of indications.

Note that the controller 400 may receive data from and/or transmit data to one or more sets of assemblies 100, 200, 300 at a time, simultaneously and in real time. That is, one set of assemblies 100, 200, 300 may be configured at a particular location along a pipeline 12, while a second set of assemblies 100, 200, 300 may be configured at a different and distinct location along the same or different pipeline 12, and a single controller 400 may interface with each distinct set of assemblies 100, 200, 300. In this way, a multitude of assemblies 100, 200, 300 may be configured in different locations along the same or with different pipelines 12, and all be controlled and/or monitored by one controller 400 (or possibly multiple controllers 400).

In this scenario, it may be preferable that each assembly 100, 200, 300 have a unique identifier (such as a serial number, IP address or other type of unique identifier) and that the controller 400 may recognize each unique identifier and communicate with each assembly 100, 200, 300 individually. In this way, the controller 400 may control the functionality of each individual assembly 100, 200, 300, and organize and manage the data received from each respective assembly 100, 200, 300. In general, it is understood that the system 10 may include one or more controllers 400 that may each control one or more sets of assemblies 100, 200, 300.

### Cloud Platform

In one exemplary embodiment hereof, the system 10 may include a cloud platform 500 that may include one or more servers (such as Internet servers) and that may include all of the components (hardware and software) necessary to transmit data to and receive data from one or more controllers 400, and to analyze or otherwise process the data it may receive and/or transmit. For example, the cloud platform 500 may include a CPU, microprocessor, microcontroller, chipset, control board, RAM, general memory, network boards, power supplies, an operating system, software, applications, scripts and any other component, application, mechanism, device or software as required. The cloud platform 500 may also receive data from and transmit data to other devices such as mobile phones, tablet computers, laptops, personal computers and other devices. In this case, it may be preferable for these devices to include an application (e.g., a mobile app) that may facilitate the communication between each device and the cloud platform 500. This will be described in further detail in other sections.

The cloud platform 500 may generally receive data transmitted to it by the controller 400 through a network 502 (e.g., the Internet, LAN, WAN, or other types of networks) for analysis and/or processing. The cloud platform 500 may also transmit information, commands or other types of data to the controller 400 that the controller may utilize while controlling, monitoring or otherwise interfacing with one or more of the assemblies 100, 200, 300. The cloud platform 500 may preferably communicate with the controller 400 through an Internet connection (e.g., via a modem through a service provider) that may include a wireless connection such as Wi-Fi via an Internet modem and router, via network cables or transmission lines, through cellular networks or by other means.

The cloud server 500 may receive measurement data from the controller 400 (e.g., data from one or more of the assemblies 100, 200, 300), may store the data in a database or in other types of data filing architectures within its memory, and may analyze the data according to models of operation, criteria, rules or other types of parameter definitions (this will be described in detail in other sections). The cloud platform 500 may also download data to another platform or facility where the data may be stored, analyzed, or otherwise evaluated, compared to the criteria of each particular model of operation and/or generally processed.

Note that the cloud platform 104 may receive data from and/or transmit data to one or more controllers 400 at a time, simultaneously and in real time. In this way, a multitude of assemblies 100, 200, 300 and/or associated controllers 400 may be configured with a variety of pipelines 12 and all controlled and monitored by one or more cloud platforms 500. It may be preferable that each controller 400 and assembly 100, 200, 300 have a unique identifier (such as a serial number, IP address or other type of unique identifier) and that the cloud platform 500 may recognize each unique identifier and communicate with each controller 400 individually. In this way, the cloud platform 500 may organize and manage the data for each controller 400 and the associated assemblies 100, 200, 300.

### Mobile Application (App) and System Usage

In one exemplary embodiment hereof, as shown in FIG. 1, the system 10 may also include a software application 602 (e.g., a mobile app) that may run on a user device 600 such as a mobile phone, a tablet computer, a laptop computer or other type of device that may be separate and distinct from the controller 400 and/or the cloud platform 500.

It may be preferable that the user device 600 be configured to communicate with the controller 400 and/or the cloud platform 500 directly, through the Internet (or other network(s)) or otherwise using wireless technologies such as WiFi, Bluetooth, cellular networks, RF or other types of communication protocols. The app 602 may help facilitate this communication and may provide an interface that may enable the user Un to control the system 10 remotely. The app 602 may enable the user Un to perform a variety of actions related to the system 10. For example, the app 602 may allow a user Un to initialize, operate, manage, configure, test, troubleshoot and generally control the assemblies 100, 200, 300, the controller 400, the cloud platform 500 and other devices and components of the system 10.

In one example, the app 602 may receive and display data from the controller 400 and/or the cloud platform 500 (e.g., measurement data from the assemblies 100, 200, 300), or may enable the user Un to send data to the controller 400 and/or the cloud platform 500 (e.g., control signals to trigger measurements, to control the setting(s) of the assemblies 100, 200, 300, etc.). For instance, the user Un may receive liquid flow rate data taken from the flow meter assembly 100, liquid pressure data taken from the pressure sensing assembly 200, and valve setting data taken from the valve assembly 300. The user Un may also set the position of the closure device(s) within the valve assembly 300 by sending positional control signals through the controller 400 and/or the cloud platform 500 to the valve assembly 300 to regulate the flow of the liquid L through the valve assembly 300 and through the pipeline 12.

The app 602 may also enable the user Un to set up models of operation for the system 10 such that the system 10 may implement the models. For example, the user Un may wish to determine the amount of water that may be used by a particular building over a specific time period. In this case, the system 10 may be configured with the main input of the water source to the building, and the user Un may utilize the system 10 to measure the amount of water that may flow through the system over the time period of interest.

Continuing with this example, knowing the total amount of water that may be used by the building over the time period, the user Un may wish to utilize the system 10 to regulate the amount of water used in order to reduce the water usage for conservation and cost saving purposes. In this case, the user Un may program the system 10 to regulate the water flow through the pipeline 12 by adjusting the valve assembly 300 to reduce the flow rate of the water. If the user may wish to reduce the amount of water usage by 30%, the closure device of the valve assembly 300 may be closed by an amount of 30% such that the flow rate through the valve assembly 300 may also be reduced by 30%. Knowing that there may not a one-to-one correlation between the reduced flow rate and the reduction of the overall water usage, the system 10 may include machine learning algorithms that may compare the flow rate setting(s) to the overall water usage and iterate the settings until the desired reduction in water consumption is reached.

In another exemplary embodiment hereof, the system 10 may utilize information provided by other metrics measured by the system 10 (e.g., water pressure) when adjusting the water flow through the pipe 12 in order to meet the water conservation and water usage goals set by the user Un. Expanding on the example above, the user Un may utilize the app 602 (or other control software utilized by the system 10) to close the closure devices within the valve assembly 300 by 30% as described. The user Un may then use the various water valves/ports within the building (e.g., the shower, bath, faucet(s), dishwasher, washing machine, outside sprinkler systems, etc.) in a manner that may represent typical usage, and may deem that this setting may provide adequate water pressure and water conservation for normal water use. Once the water flow may be set, the system 10 may then take one or more water pressure measurements within the pipeline 12 at the corresponding water valve assembly 300 setting and record the measured water pressure in its memory. This may provide a baseline water pressure setting for typical water use at the new valve assembly 300 setting.

However, if additional water valves/ports may then be used simultaneously (e.g., by additional visitors staying at the residence using several showers, faucets, etc. at the same time) then there may be an increase in the simultaneous water usage such that the water pressure within the pipeline 12 may drop below a predefined minimum water pressure threshold and no longer be adequate. In this embodiment, the system 10 may continually monitor the water pressure within the pipeline 12 using the pressure sensing assembly 200 and if/when the water pressure may drop below the predefined minimum water pressure threshold due to additional water usage, the system 10 may adjust the closure device(s) within the valve assembly 300 to allow more water flow through the valve assembly 300 such that the measured water pressure may increase to an adequate level (e.g., equal to or above the predefined minimum water pressure threshold). In this way, the system 10 may ensure adequate water pressure during this time period of higher water usage.

Then, when the simultaneous water usage may be reduced (e.g., the visitors may leave), the system 10 may recognize this fact through its continual water pressure measurements, and may readjust the closure device(s) within the valve assembly 300 to reduce the water flow rate back to the desired level. Note that this example is meant for demonstration purposes and that the system 10 may monitor the water pressure of the liquid L through the pipeline 12 at any time (continually, at intervals or on command) and may adjust the valve assembly 300 accordingly (continually, at intervals or on command) to maintain an adequate water pressure through the pipeline 12 at any and/or all times. Note also that the user Un may set and/or change the predefined minimum water pressure threshold at any time. It is also understood that the system 10 may utilize other information provided by other measured metrics (e.g., water flow measurements taken by the water flowmeter assembly 100) when adjusting the closure device(s) of the valve assembly 300 to achieve goals set by the user Un.

The system 10 may also allow for the water flow through the pipeline 12 to be monitored and/or regulated differently at different times during the day, during different days of the week, and so on. For example, the system 10 may reduce the water flow through the valve assembly 300 during peak usage hours and less so during off-peak hours. In this case, the artificial intelligence of the system may allow the system 10 to learn what times of day may need to regulated (as well as what days of the week for example), such that it may optimally regulate the water flow to achieve the desired outcome.

In another exemplary embodiment, the system 10 may detect problems with the water pipelines with which it may be configured. For example, if there may be a leak in the pipeline 12, the system 10 may identify the leak by monitoring the water pressure in the pipe 12 by utilizing the pressure sensing assembly 200. For instance, an unexpected drop in water pressure while the other measured metrics remain constant may indicate the existence of a water leak in the pipeline 12. In such a case, the system 10 may be programmed to recognize the outlier data and bring it to the attention of the user Un as desired. The system 10 may also be programmed to shut off the water supply when such a problem is identified.

In another exemplary embodiment hereof, the system 10 may automatically shut down the water running through a pipeline 12 in the event of an emergency such as an earthquake, fire, storm conditions, or other type of emergencies. In this case, the user Un may initiate the shutdown, or the system 10 may receive an alert (e.g., over the Internet) from local authorities such as the fire department instructing the system 10 to shut off the water. This alert may be in the form of an electric signal or other type of communication that may trigger the system 10 to configure itself as directed.

In another exemplary embodiment hereof, the system 10 may generate reports that may represent the measurement data taken over any time period of interest (e.g., hourly, daily, weekly, monthly, yearly, etc.). In this way, the user Un may utilize the report(s) to implement water conservation programs as necessary. This may allow the user Un to reduce water consumption thus saving water and money.

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and Understand, upon reading this description, that the various processes described herein may be implemented by, e.g., appropriately programmed general purpose computers, special purpose computers and computing devices. One or more such computers or computing devices may be referred to as a computer system.

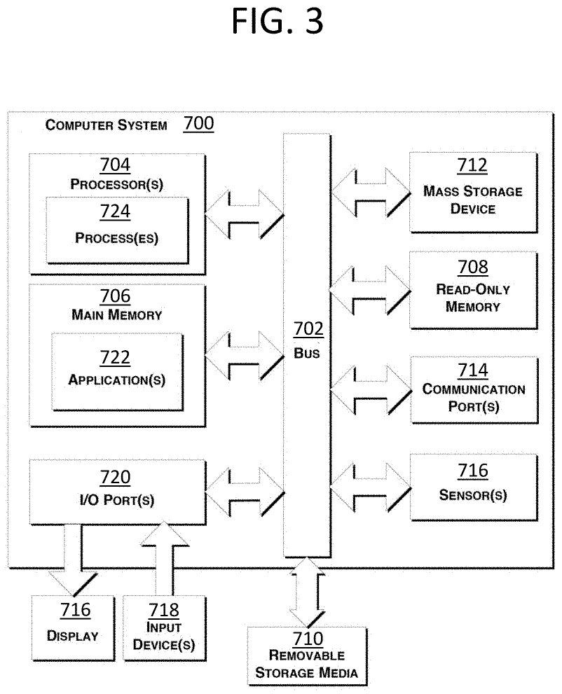

FIG. 3 is a schematic diagram of a computer system 700 upon which embodiments of the present disclosure may be implemented and carried out.

According to the present example, the computer system 700 includes a bus 702 (i.e., interconnect), one or more processors 704, a main memory 706, read-only memory 708, removable storage media 710, mass storage 712, and one or more communications ports 714. Communication port(s) 714 may be connected to one or more networks (not shown) by way of which the computer system 700 may receive and/or transmit data.

As used herein, a “processor” means one or more microprocessors, central processing Units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 704 can be any known processor, such as, but not limited to, an Intel® Itanium® or Itanium 2® processor(s), AMD® Opteron® or Athlon MP® processor(s), or Motorola® lines of processors, and the like. Communications port(s) 714 can be any of an Ethernet port, a Gigabit port using copper or fiber, or a USB port, and the like. Communications port(s) 714 may be chosen depending on a network such as a Local Area Network (LAN), a Wide Area Network (WAN), or any network to which the computer system 700 connects. The computer system 700 may be in communication with peripheral devices (e.g., display screen 716, input device(s) 718) via Input/Output (I/O) port 720.

Main memory 706 can be Random Access Memory (RAM), or any other dynamic storage device(s) commonly known in the art. Read-only memory (ROM) 708 can be any static storage device(s) such as Programmable Read-Only Memory (PROM) chips for storing static information such as instructions for processor(s) 704. Mass storage 712 can be used to store information and instructions. For example, hard disk drives, an optical disc, an array of disks such as Redundant Array of Independent Disks (RAID), or any other mass storage devices may be used.

Bus 702 communicatively couples processor(s) 704 with the other memory, storage and communications blocks. Bus 702 can be a PCI/PCI-X, SCSI, a Universal Serial Bus (USB) based system bus (or other) depending on the storage devices used, and the like. Removable storage media 710 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 706 is encoded with application(s) 722 that support(s) the functionality as discussed herein (the application(s) 722 may be an application(s) that provides some or all of the functionality of the services/mechanisms described herein). Application(s) 722 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 704 accesses main memory 706 via the use of bus 702 in order to launch, run, execute, interpret or otherwise perform the logic instructions of the application(s) 722. Execution of application(s) 722 produces processing functionality of the service related to the application(s). In other words, the process(es) 724 represent one or more portions of the application(s) 722 performing within or upon the processor(s) 704 in the computer system 700.

It should be noted that, in addition to the process(es) 724 that carries(carry) out operations as discussed herein, other embodiments herein include the application 722 itself (i.e., the Un-executed or non-performing logic instructions and/or data). The application 722 may be stored on a computer readable medium (e.g., a repository) such as a disk or in an optical medium.

According to other embodiments, the application 722 can also be stored in a memory type system such as in firmware, read only memory (ROM), or, as in this example, as executable code within the main memory 706 (e.g., within Random Access Memory or RAM). For example, application(s) 722 may also be stored in removable storage media 710, read-only memory 708, and/or mass storage device 712.

Those skilled in the art will understand that the computer system 700 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and Understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be Understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used herein, including in the claims, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, Unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

As used herein, including in the claims, the term “automatic,” with respect to an action, generally means that the action occurs with little or no human control or interaction. The term “automatic” also includes the case of no human control or interaction. Thus, e.g., the term “triggered automatically” means “triggered with little or no human control or interaction,” and includes the case “triggered with no human control or interaction.”

As used herein, including in the claims, singular forms of terms are to be construed as also including the plural form and vice versa, Unless the context indicates otherwise. Thus, it should be noted that as used herein, the singular forms “a,” “an,” and “the” include plural references Unless the context clearly dictates otherwise.

Throughout the description and claims, the terms “comprise”, “including”, “having”, and “contain” and their variations should be Understood as meaning “including but not limited to”, and are not intended to exclude other components Unless specifically so stated.

It will be appreciated that variations to the embodiments of the invention can be made while still falling within the scope of the invention. Alternative features serving the same, equivalent or similar purpose can replace features disclosed in the specification, Unless stated otherwise. Thus, Unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.”) and the like, is merely intended to better illustrate the invention and does not indicate a limitation on the scope of the invention Unless specifically so claimed.

Any acts described in the specification may be performed in any order or simultaneously, Unless the context clearly indicates otherwise.

All of the features and/or acts disclosed herein can be combined in any combination, except for combinations where at least some of the features and/or acts are mutually exclusive. In particular, preferred features of the invention are applicable to all aspects of the invention and may be used in any combination.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams Unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be Understood that the invention is not to be limited to the disclosed embodiment, but on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

What is claimed:

1. A method of controlling the flowrate of a liquid or gas through a passageway, the method comprising the steps:
(A) using a controller to set a first minimum liquid or gas pressure threshold for the liquid or gas flowing through the passageway;
(B) using a variable valve to set the flowrate of the liquid or gas flowing through the passageway;
(C) using a pressure sensing device to measure the pressure of the liquid or gas flowing through the passageway;
(D) comparing the measured pressure in (C) with the minimum pressure threshold set in (A); wherein
(D)(1) if the measured pressure in (C) is less than the minimum pressure threshold set in (A), adjusting the variable valve to increase the flowrate of the liquid or gas flowing through the passageway; and
(D)(2) using the pressure sensing device to measure the pressure of the liquid or gas through the passageway;
(E) repeating steps (D)(1) to (D)(2) until the measured pressure of the liquid or gas through the passageway in (D)(2) is greater than or equal to the minimum liquid or gas pressure threshold set in (A).

2. The method of claim 1 further comprising the steps:
(F) using the controller to set a second minimum liquid or gas pressure threshold for the liquid or gas flowing through the passageway;
(G) using a pressure sensing device to measure the pressure of the liquid or gas flowing through the passageway;
(H) comparing the measured pressure in (C) with the minimum pressure threshold set in (A); wherein
(H)(1) if the measured pressure in (C) is less than the minimum pressure threshold set in (A), adjusting the variable valve to stop the flow of the liquid or gas flowing through the passageway.

3. The method of claim 2 wherein the second minimum liquid or gas pressure threshold is less than the first minimum liquid or gas pressure threshold.

4. The method of claim 2 further comprising the steps:
(I) alerting a user of the passageway of the condition in (H)(1).

5. The method of claim 1 wherein the using a controller to set a first minimum liquid or gas pressure threshold in (A) includes using a mobile application configured to communicate with the controller.

6. The method of claim 1 wherein the steps (B) through (E) are performed by the controller.

7. The method of claim 1 further comprising the steps:
(A)(1) storing the first minimum liquid or gas pressure threshold to a cloud platform.

8. The method of claim 1 further comprising the steps:
(C)(1) storing the measured liquid or gas pressure to a cloud platform.

9. The method of claim 1 wherein the passageway is a water pipeline.

10. A system for controlling the flowrate of a liquid or gas through a passageway, the system comprising:
a flowrate meter configured to measure the flowrate of the liquid or gas through the passageway;
a pressure sensing device configured to measure the pressure of the liquid or gas in the passageway;
a variable valve configured to control the flowrate of the liquid or gas through the passageway; and
a controller;
wherein the controller controls the variable valve to set the flowrate of the liquid or gas flowing through the passageway, and the flowrate meter to measure the resulting flowrate.

11. The system of claim 10 further comprising a cloud platform configured with the controller.

12. The system of claim 11 further comprising a mobile application configured to interface with the controller and/or the cloud platform.

13. The system of claim 12 wherein the mobile application instructs the controller to control the variable valve to set the flowrate of the liquid or gas flowing through the passageway, and the flowrate meter to measure the resulting flowrate.

14. The system of claim 10 wherein the passageway is a water pipeline.

15. The system of claim 10 wherein the controller controls the pressure sensing device to measure the pressure of the liquid or gas in the passageway.
